(19) United States
(12) Patent Application Publication
(10) Pub. No.: US 2008/0270732 A1
(43) Pub. Date: Oct. 30, 2008

(54) Adaptive arena assignment based on arena contentions

(76) Inventor: Weidong Cai, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,424

(22) Filed: Apr. 27, 2007

(51) Int. Cl. G06F 12/00

(52) U.S. Cl. 711/173

(57) ABSTRACT

An embodiment of the invention provides an apparatus and a method for an adaptive arena assignment based on arena contentions. The apparatus and method include: receiving a request for memory from a software thread; determining a lock hit counter with a lowest value; and assigning the software thread to an arena associated with lock hit counter.

### TECHNICAL FIELD

Embodiments of the invention relate generally to an adaptive arena assignment based on arena contentions.

### BACKGROUND

A software thread is an independent flow of control within a program process. In computer systems, a program process is an instance of an application that is running in a computer. A software thread is formed by a context and a sequence of instructions that are being executed by a processor. The context may include a register set and a program counter.

In certain programming languages such as, for example, C languages or Pascal, a “heap” is an area of pre-reserved computer memory that a program process can use to store data in some variable amount that will not be known until the program is running. For example, a program may accept different amounts of input for processing from one or more user applications and then perform the processing on all of the input data, concurrently. Having a certain amount of heap already obtained from the operating system is generally faster than requesting the operating system for storage space every time that the program process will need to use storage space.

In one previous approach, the malloc(3c) routine uses a single lock to guard the heap from software threads that contend for dynamic memory (i.e., virtual memory) from the heap. The malloc(3c) is a known standard library routine or function for storage allocation. If an application is a multithreaded application on multi-CPU machines, the multiple software threads in the application will contend for the single lock and may result in a significant performance bottleneck that affects throughput. The single lock for guarding a heap is implemented in, for example, the HP-UX 11.00LR operating system from HEWLETT-PACKARD COMPANY.

In another previous approach, the heap is partitioned into chunks of memory spaces that are known as “arenas”, in order to overcome the performance bottleneck from the use of a single lock. Each arena is guarded by its own lock, and a lock prevents corruption of the heap by preventing the multiple threads from obtaining the same arena at the same time. The use of multiple arenas with associated locks reduces the contention that occurs in the previous systems that use a single lock for guarding a heap. Different software threads that are assigned to different arenas are able to simultaneously obtain and use the memory space. A thread can use an arena that is not being used by another thread. The threads are assigned to particular arenas in a round-robin manner and based upon the identification numbers of the threads (i.e., thread IDs). Multiple arenas that are guarded by associated locks are implemented in, for example, the HP-UX 11.00 operating system from HEWLETT-PACKARD COMPANY.

The multi-arena approach is a random and static solution because it does not take into account the thread behavior and workload, and also does not take into account the runtime dynamic characteristics of arenas. As a result, this prior approach may, for example, result in heavy thread contention for certain arenas in the heap, and low or no thread contention for other arenas in the heap. In other words, this prior approach does not evenly distribute the thread workload to each arena and may cause “hotspots” which are arenas that receive a heavy thread workload as compared to other arenas. This uneven distribution of thread contention may also result in a performance bottleneck that affects throughput.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a flow diagram of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

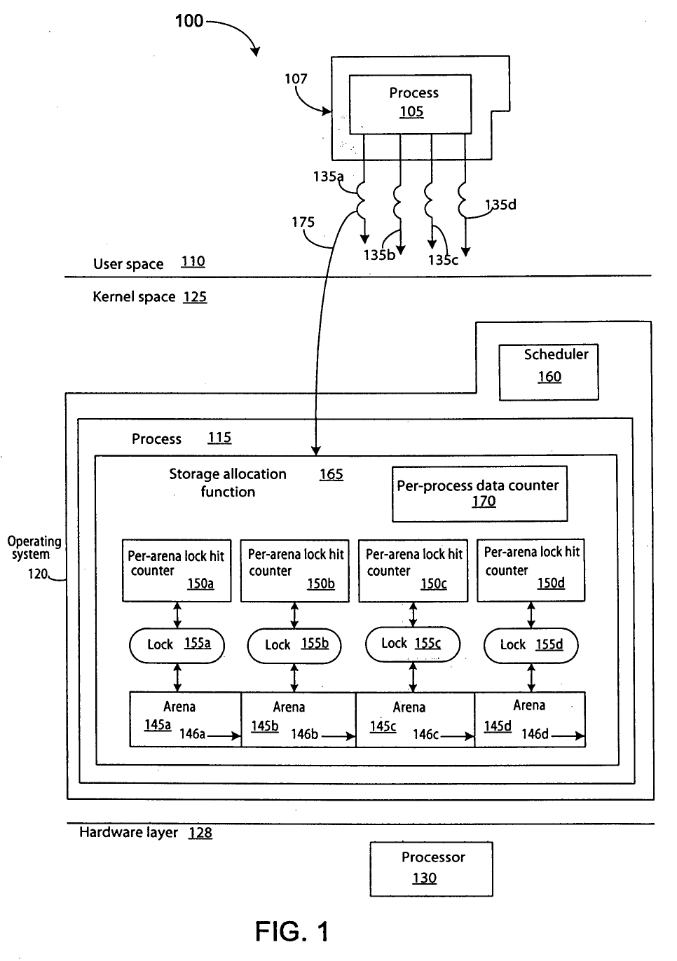

FIG. 1 is a block diagram of a system (apparatus) 100 in accordance with an embodiment of the invention. The system 100 is typically a computer system that is in a computing device. A process 105 of an application program 107 will execute in a user space 110. It is understood that more than one application program can execute in the user space 110. A process 115 of an operating system 120 will execute in a kernel space 125. A hardware layer 128 includes a processor 130 that executes the application program 107, operating system 120, and other software that may be included in the system 100. Other known hardware components for use in computing operations are also included in the hardware layer 128.

As discussed in additional details below, an embodiment of the invention introduces a new arena-assignment policy for software threads (e.g., threads 135a-135d), based on the amount (degree) of contentions by the threads on each arena in a heap 140. A software thread is formed by a context and a sequence of instructions that are being executed by a processor. The context may be formed by a register set and a program counter.

The heap 140 is a virtual memory for use by the threads. The number of threads for a process 105 may vary in number. A thread (that needs to use the virtual memory) is assigned to an arena that is least contended (or is among the least contended) by the software threads. In the example of FIG. 1, the heap 140 is partitioned into the arenas 145a-145d, although the number of arenas in a heap may vary. The boundaries of an arena can be set in the data structure attributes in the operating system 120. The boundary of an arena is dynamic and is typically not fixed but can expand to an upper bound amount. Each arena has a marker (e.g., markers 146a-146d) which is the upper bound of an arena. Arenas are implemented in various operating systems in commercially available products. The marker is set as an attribute in a data structure of the operating system 120. As an example, an upper bound for an arena can be set to approximately 100 megabytes, although other memory space amounts may be used for the upper bound of an arena.

As discussed below, the per-arena lock hit counters 150a-150d is maintained for each arena 145a-145d, respectively, where a lock hit counter indicates the number of times that threads have obtained the locks (mutexes) that guards the arenas. In the example of FIG. 1, the locks 155a-155d are used to guard the arenas 145a-145d, respectively. As known to those skilled in the art, a lock is a bit value (logical “1” or logical “0”)) that is set in a memory location of a shared object (e.g., an arena). For example, a software thread (e.g., thread 135a) will set the bit value in a lock when the thread has ownership of the lock. The software thread can access or perform operations in an arena when the software thread has ownership of the lock that guards the arena. Therefore, when a thread has ownership of a lock, other threads will not have ownership of that lock and, therefore, these other threads will not be able to use and will not be able to perform operations on the arena that is guarded by the lock.

When a thread is attempting to obtain a lock that is currently held by another thread, then that thread attempting for the lock is placed in a busy waiting state (spin state) by a scheduler 160. As known to those skilled in the art, busy waiting is when the thread waits for an event (e.g., the availability of the lock) by spinning through a tight loop or a timed-delay loop that polls for the event on each pass by the thread through the loop. The scheduler 160 can be implemented by use of known programming languages such as, e.g., C or C++, and can be programmed by use of standard programming techniques.

A storage allocation function 165 will allocate an arena for use by a requesting thread, based on the amount of contentions by the threads among the arenas, as discussed below. The storage allocation function 165 can also perform the various known operations that are performed by the known the malloc(3c) storage allocation routine. For example, the malloc(3c) routine can call a read function that permits reading by threads of data in the arenas. The process 115, for example, can execute the storage allocation function 165. The storage allocation function 165 can be implemented by use of known programming languages such as, e.g., C, C++, Pascal, or other types of programming languages, and can be programmed by use of standard programming techniques.

In an embodiment of the invention, the storage allocation function 165 permits a new thread-to-arena assignment policy that considers the amount of runtime thread contentions of each arena. Each arena uses an associated per-arena data counter in order to keep track of recent thread contentions on a lock that guards an arena. The storage allocation function 165 increments the per-arena data counter value whenever a thread acquires a lock associated with the arena. The storage allocation function 165 also increments a per-process data counter (global counter) 170 whenever a software thread sends a request for the use of an arena. For example, if the thread 135a (or any other thread) sends a request 175 for the use of an arena to the function 165, then the global counter 170 value is incremented for each received request 175. Therefore, the global counter 170 permits the storage allocation function 165 to track the recent number of thread requests for storage. The storage allocation function 165 sets the values of the per-arena lock hit counters 150a-150d and the value of the global counter 170 as data structure attributes in the operating system 120.

In an embodiment of the invention, when a new request (e.g., request 175) for memory space is received by the operating system 120 from a thread, the function 165 will increment the global counter value 170. The function 165 also check the per-arena lock hit counter values 150a-150d which indicate the number of occurrences that a lock has been held by a thread (i.e., lock hits). Therefore, the lock hit counter values 150a-150d indicate the workload (number of thread accesses) of the arenas 145a-145d, respectively. The function 165 will then assign the requesting thread to an arena with the smallest value (or with one of the smallest values) for the per-arena lock hit counter 150a. A low lock hit counter value means that the arena which corresponds to the low lock hit counter value has a low workload (i.e., fewer threads that are requesting for use of memory space from this arena). As an example, if the lock hit counter 150a has the smallest value among the lock hit counters 150a-150d, then the function 165 will assign the requesting thread 135a to the corresponding arena 145a. The thread 135a then obtains the corresponding lock 155a and the function 165 will increment the corresponding lock hit counter value 150a. The thread 135a can then access the corresponding arena 145a and use that arena 145a for various thread operations.

The storage allocation function 165 will increment the global counter 170 for each received request for memory from a thread in user space 110. Once the global counter 170 reaches a threshold amount (e.g., value of 10,000 or other suitable values), the function 165 will reset the global counter 170 to a reset value such as zero (0), and the function 165 will also reset all of the per-arena lock hit counters 150a-150d to the reset value. The global counter 170 serves to define an approximate time interval that the thread contention determination is based upon. In other words, the values of the lock hit counters 150a-150d is limited to this time interval which re-starts whenever the global counter 170 is reset to the reset value. It is typically advantageous to examine the immediate past time interval, when determining the contentions for the arenas by threads. Setting the time interval value at a longer time (or not using a global counter 170 to define a time interval on the thread contentions) may possibly not provide a more accurate observation of the thread contentions for the arenas. For example, an arena may have been heavily contended by threads at a longer previous particular time period, but may not have been heavily contended by threads in the immediate or more recent particular time period. Therefore, the global counter 170 determines the arena workload (the contention by threads for an arena lock) in the past few seconds or past defined time as determined by the threshold value of the global counter 170. The use of the global counter 170 also avoids the use of time-related system calls to the operating system 120, as these calls are typically expensive (time consuming).

The above-discussed arena-assignment policy advantageously distributes the thread requests for memory among the arenas and avoids the situation where threads heavily compete for arena locks of only certain arenas and not compete for arena locks of other arenas. In other words, with this new contention-based arena-assignment policy, when an arena is already heavily contended, new threads that are requesting for memory will be directed to other less contended arenas. Since the thread-to-arena assignments are determined based on the changing workloads that may occur among the arenas, this assignment policy is adaptive by taking into account the changes in the arena workloads. As a result, an embodiment of the invention advantageously avoids forming “hotspots” which are arenas that receive heavy thread workload compared to other arenas.

Therefore, embodiments of the invention advantageously takes into account the current contention situation on each arena and accordingly makes a decision on the arena for a thread based upon the current contention situation on each arena. An embodiment of the invention also improves the distribution of thread work load among arenas and avoids in causing bottlenecks in certain arenas. Additionally, an embodiment of the invention advantageously does not require significant component and software overhead to implement.

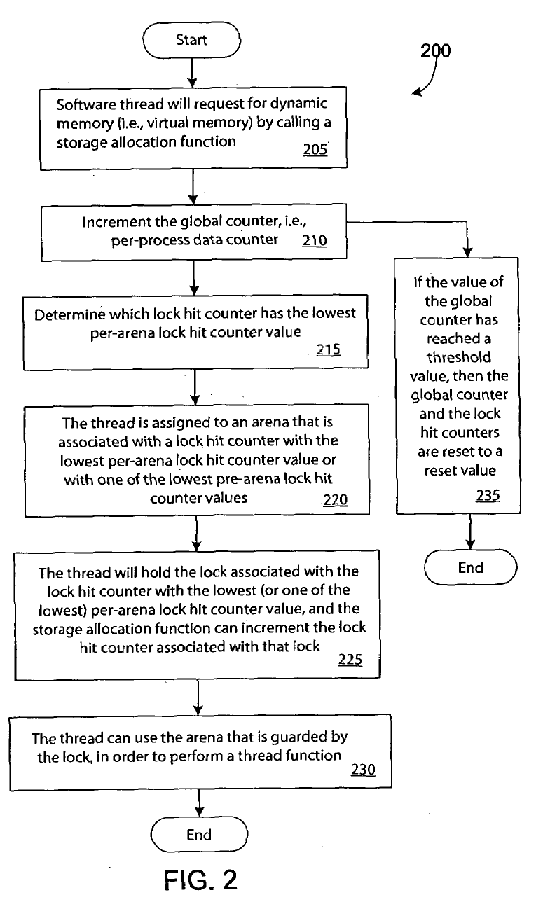

FIG. 2 is a flow diagram of a method 200, in accordance with an embodiment of the invention. An application, which is implemented in, e.g., the C programming language, will run as a process with software threads that perform various functions. Each thread may need to obtain dynamic memory in order to perform their thread functions. A thread will request (205) for dynamic memory (i.e., virtual memory) by calling a storage allocation function 165 (e.g., malloc function). The function 165 will increment (210) the global counter in response to the call from the thread. The function 165 determines (215) which lock hit counter has the lowest per-arena lock counter value among the various lock hit counters that are associated with locks that guard corresponding arenas. The function 165 assigns (220) the thread to an arena that is associated with a lock hit counter with the lowest per-arena lock hit counter value (or with one of the lowest per-arena lock hit counter values). The thread will obtain the dynamic memory from the arena which has the lowest per-arena lock hit counter value. Therefore, a thread is assigned or mapped to an arena based upon the contention (workload) of the threads among the arenas. The thread will hold (225) the lock associated with the arena with the lowest (or one of the lowest) per-arena lock hit counter value, and after the thread has obtained the lock to that arena, the per-arena lock counter value is incremented. The thread can then use (230) the arena that is guarded by that lock, so that the thread has dynamic memory in order to perform a thread function. The thread will release the lock after the thread has acquired dynamic memory from the arena. The function 165 also resets (235) the global counter and all of the lock hit counters to a reset value (e.g., zero) if the global counter reaches a threshold value. The step of resetting the global counter in block 235 is typically performed after performing the steps in block 230.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for an adaptive arena assignment based on arena contentions, the method comprising:
receiving a request for memory from a software thread;
determining a lock hit counter with a lowest value; and
assigning the software thread to an arena associated with lock hit counter.

2. The method of claim 1, wherein the lock hit counter indicates a thread contention amount for the arena.

3. The method of claim 1, further comprising:
incrementing the lock hit counter when the software thread holds a lock associated with the lock hit counter.

4. The method of claim 1, further comprising:
holding, by the software thread, a lock associated with the arena.

5. The method of claim 4, further comprising:
using, by the thread, the arena that is guarded by the lock.

6. The method of claim 5, further comprising:
releasing, by the thread, the lock.

7. The method of claim 1, further comprising:
incrementing a global counter after the request is received from the software thread.

8. The method of claim 7, further comprising:
setting the global counter and each lock hit counter to a reset value, if the global counter reaches a threshold value.

9. The method of claim 1, wherein each arena is guarded by an associated lock.

10. The method of claim 9, wherein each lock is associated with a corresponding lock hit counter.

11. The method of claim 1, wherein each arena belongs to a virtual memory.

12. An apparatus for an adaptive arena assignment based on arena contentions, the apparatus comprising:
an operating system including a storage allocation function that is configured to receive a request for memory from a software thread, determine a lock hit counter with a lowest value, and assign the software thread to an arena associated with lock hit counter.

13. The apparatus of claim 12, wherein the lock hit counter indicates a thread contention amount for the arena.

14. The apparatus of claim 12, wherein the storage allocation function increments the lock hit counter when the software thread holds a lock associated with the lock hit counter.

15. The apparatus of claim 12, wherein the software thread holds a lock associated with the arena.

16. The apparatus of claim 15, wherein the software thread uses the arena that is guarded by the lock.

17. The apparatus of claim 16, wherein the software thread releases the lock.

18. The apparatus of claim 12, wherein the storage allocation function increments a global counter after the request is received from the software thread.

19. The apparatus of claim 18, wherein the storage allocation function sets the global counter and each lock hit counter to a reset value, if the global counter reaches a threshold value.

20. The apparatus of claim 12, wherein each arena is guarded by an associated lock.

21. The apparatus of claim 20, wherein each lock is associated with a corresponding lock hit counter.

22. The apparatus of claim 12, wherein each arena belongs to a virtual memory.

23. An apparatus for an adaptive arena assignment based on arena contentions, the apparatus comprising:
means for receiving a request for memory from a software thread;
means for determining a lock hit counter with a lowest value; and
means for assigning the software thread to an arena associated with lock hit counter.

24. An article of manufacture comprising:
a machine-readable medium having stored thereon instructions to:
receive a request for memory from a software thread;
determine a lock hit counter with a lowest value; and
assign the software thread to an arena associated with lock hit counter.
